(19) United States
(12) Patent Application Publication
(10) Pub. No.: US 2022/0048685 A1
(43) Pub. Date: Feb. 17, 2022

(54) Platform Storage Security System

(71) Applicant: James M. Justitz, San Antonio, TX (US)

(72) Inventor: James M. Justitz, San Antonio, TX (US)

(21) Appl. No.: 17/303,144

(22) Filed: May 21, 2021

Related U.S. Application Data
(60) Provisional application No. 62/706,381, filed on Aug. 13, 2020.

(51) Int. Cl. B65D 71/00

(52) U.S. Cl. CPC B65D 71/0092

(57) ABSTRACT

The Platform Storage Security System is an apparatus comprising a set of tamper resistant metal pallet securing clamps designed to fit the edges or sides of palletized materials which are connected to and secured to each other across the surface of said palletized materials so as to enable the securing of said palletized materials thereby preventing or resisting the theft of the secured materials.

### FIELD OF THE INVENTION

The subject invention relates generally to security devices, and more particularly to a security device for securing products or product packing devices such as pallets and crates used, for example, in construction material distribution.

This invention relates generally to an Adjustable Pallet Clamp Security System in the form of an adjustable locking apparatus for securing pallets of materials to be stored on a construction site.

### BACKGROUND OF THE DISCLOSURE

Reusable packing and shipping devices such as pallets, crates, trays, boxes, etcetera have been used in the shipping of goods such as construction materials and retail products. Such packing and shipping devices are often left unattended in open areas where they are exposed to theft or damage. Building materials such as lumber are often similarly left exposed in construction areas and are favorite targets of theft and vandalism.

There is a need for a system or apparatus to secure materials packed, shipped, and stored on pallets.

### BRIEF SUMMARY OF THE INVENTION

According to a first aspect of the invention, there is a Security Device for securing a package onto a transportable platform comprising all the features of claim 1. According to another aspect of the invention there is a Transportable Platform Security System comprising all features of claim 2. According to another aspect of the invention there is a Transportable Platform Security System comprising all features of claim 3. Further features of the invention are disclosed in dependent claims.

The Transportable Platform Security System includes of a Security Device for securing pallets of materials to be stored on a construction site, in a warehouse, in a shipping yard, on a trailer, or in another place where packages may be stored. An advantage of the adjustable security device is to enable the securing of construction materials or other goods to the pallets they are packed, shipped, or stored upon so as prevent theft.

Preferably the security device is suitable for securing a package onto a transportable platform , wherein the package includes construction retail goods or other goods which may be transported and stored on a pallet. The security device may comprise these: a post; first, and second edge units held an adjustable distance apart by the post, wherein the first edge unit is shaped to receive a edge of a platform ; and an operable, lockable press or collar or other adjustment device connected to the post to press the edge units toward each other. The post, the first and/or second edge unit and the press may be bundled together unassembled as a kit of parts. The edge units may have a convenient stackable shape.

Preferably the distance between the first and second edge units may be operating the press to urge one of the edge units, toward and/or away from the other.

Preferably the first edge unit and the second edge unit each have an internal corner to receive of a pallet and a package. The material of the edge units may be a metal or alloy or other strong material including but not limited to steel, Kevlar, stainless steel, polymer or ceramic.

Preferably at least one of the security devices of the system has a first edge unit 120, 220 and second edge unit , which both have a internal corner to secure to vertically aligned the edges of the platform and package.

The invention will now be described, by way of example.

### BRIEF DESCRIPTION OF THE FIGURES

The broken lines shown in the figures are for the purpose of illustrating the pallet being secured by the apparatus of the present invention and they form no part of the apparatus but represent the construction materials or retail good to be secured with the present invention.

FIG. 1 is a three-dimensional perspective view of a first security device; and second security device .

FIG. 2 is a three-dimensional perspective view of a covered package on a platform secured with edge-unit style units of a security system shown on two edge s of said covered package on the platform: and

FIG. 3 is a three-dimensional perspective view of a covered package on a platform secured with edge-unit style units of a security system shown on distal opposite edge-ends of the covered package on the platform.

FIG. 4 is a three dimensional perspective view of a package on a platform.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

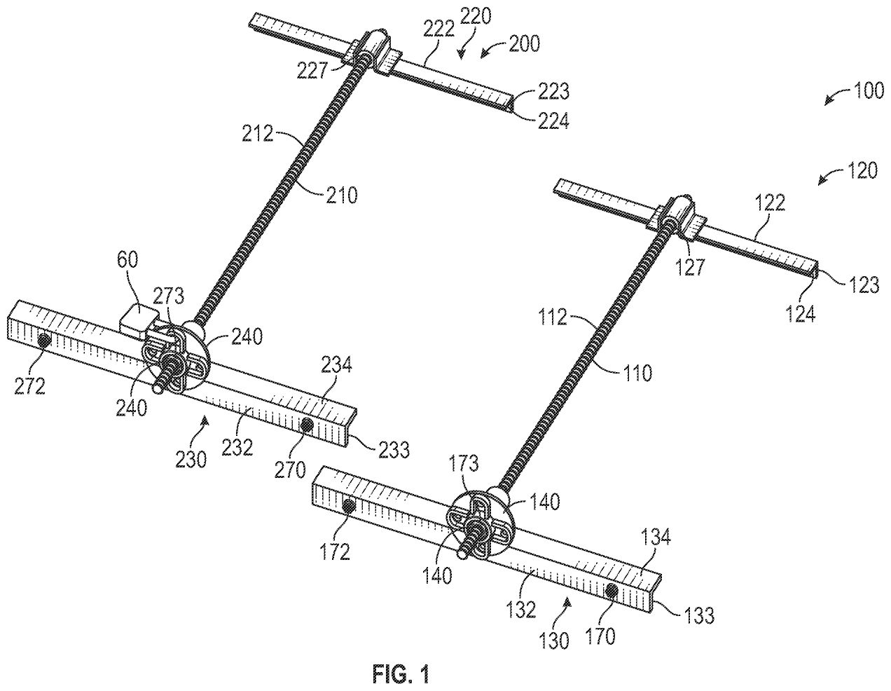

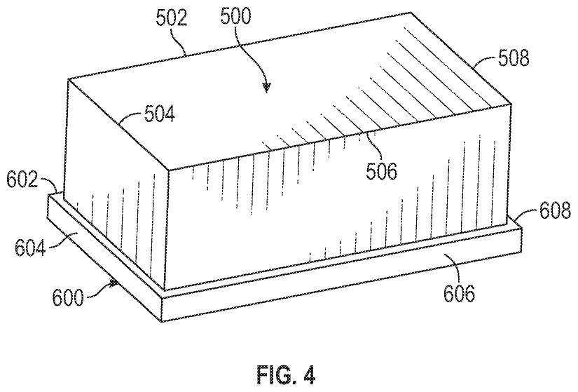

Referring to the Figures, there is shown in FIG. 1, a security device 100 for securing a package 500 onto a platform 600. In FIG. 4, there is an illustration of the package 500 and the platform 600. The package 500 rests on the platform 600 and may be freely lifted off the platform 600.

Industries such as the construction industry, the agricultural and food production industry, industrial factory industries, and even individuals often use a transportable platform such as a pallet. The platform 600 shown in FIG. 4 could be a pallet. The package 500 shown in FIG. 4 could be an item or items stored on the pallet 600.

The transportable platform 600 is plate-like or comprises a ledge having a perimeter edge 612. The perimeter edge 612 of the ledge is where a perimeter edge of package 500 meets an under-edge of the platform or ledge.

The platform 600 is shown as four edged, although it is not essential for the platform 600 to have four edges. The platform has four edges 602, 604, 606, 608.

The package 500 is illustrated in FIG. 4 as block-like in shape although this is not necessary. The package 500 may be a crate to store items. It may be a stack of boards. It may be a collection of things.

The package 500 has top edges 502, 504, 506, 508 where two perimeter edges of the package meets a top edge of the package 500. The top edge is distal from the platform 600. Each top edge of the package 502, 504, 506, 508 is vertically above a respective edge 602, 604, 606, 608 where the under-edge of the package 500 meets two perimeter edges of the platform. A post could extend from a edge 602, 604, 606, 608 of the platform and could extend parallel to the platform top on which the package 500 rests so that the post extends vertically upward. This post could thus go straight up vertically from the edges 602, 604,606, 608 at the under-edge of the platform to the respective edges 502, 504, 506, 508 at the top of the package 500.

The security device 100 shown in FIG. 1 has a post 110 arranged to extend from one of the edges 602, 604, 606, 608 at the under-edge of the platform to the respective edge 502, 504, 506, 508 at the top of the package 500.

The security device 100 comprises two edge units: a first edge unit 120 and a second edge unit 130. The post 110 holds the edge units 120, 130. The first edge unit 120 is arranged to move along the post 120 and/or the second edge unit 130 is arranged to move along the post 110 so that the distance of separation between the two edge units 120, 130, may be adjusted to the distance between respective edges of the platform 600 and package, such as for example the distance between edge of 602 at the under-edge of the platform 600 and the edge of 502 of the package 500 which is vertically above.

The post 110 has along it threads or notches for a nut or a pawl of a ratchet. Thus the two edge units 120, 130 may be urged closer together by a ratchet or a security collar with a tightening nut 140 on the post 110. The second edge unit 130 is intermediate first edge unit 120 the security collar with tightening nut 140. So as the security collar with tightening nut 140 is turned on the threads of the post 110, the security collar with tightening nut 140 presses the second edge unit 130 toward first edge unit 120.

The security collar with tightening nut 140 has an aperture to receive a shank of a padlock 60 to prevent the security collar with tightening nut 140 from being turned on the post 110.This prevents unauthorized increase in separation distance between the first 120, 220 and second edge units 130, 230. The second edge unit 130,230 may have a through hole 173, 273 such as shown in FIG. 1 to receive the shank of the padlock 60. The security collar with tightening nut 140 may then be locked to the first 120, 220 or second edge unit 130, 230 to prevent the unauthorized increase in separation distance.

The first edge unit 120 or the second edge unit 130, but not both, may be fixed to the post, while the other non-fixed edge unit 120, 130 is movable and adjustable distance and may be urged closer to the fixed edge unit 120, 130 by the security collar with tightening nut 140.

The first edge unit 120 and/or the second edge unit 130 have an unthreaded through hole 127, 227 through which post 110, 210 passes through. The through hole diameter may have a slip fit tolerance with the diameter of the post 110. This prevents the first and/or the second edge unit 120, 130 from wobbling on the post 110.

The post 110 may have a spine 112 or groove extending axially on the exterior to receiving corresponding groove or spine 127 in the first edge unit 120 and/or the second edge unit 130. The spine 110,210 engages the groove 112 to prevent the first edge unit 120 and/or the second edge unit 130 from turning around the axis of the post 110.

So the first and second edge units 120, 130 are held in fixed orientation an adjustable distance apart by post 110.

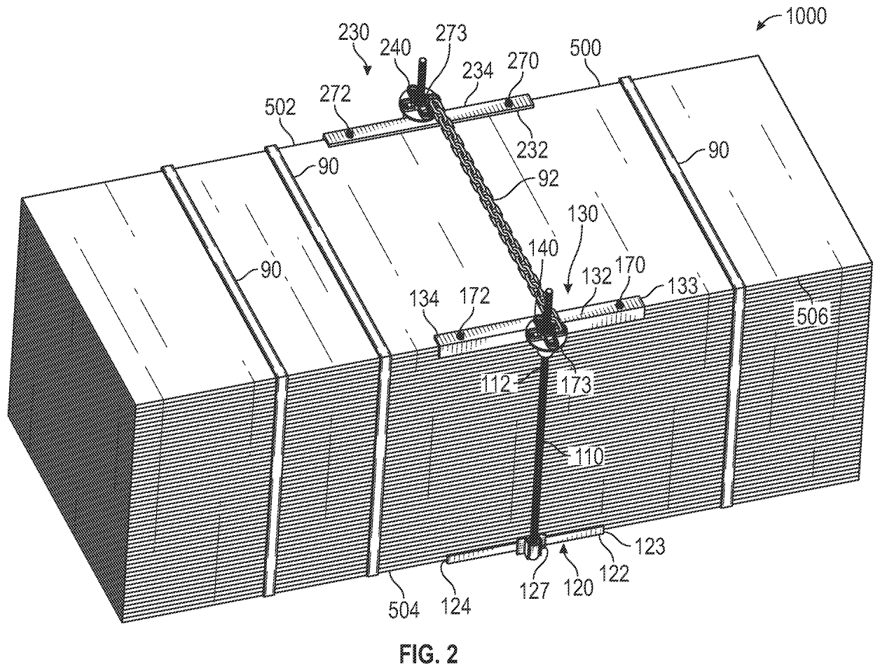

As shown in FIG. 2, first security device 100 secures a covered package 500 to a pallet 600. The first edge unit 120 engages the under-edge edge 602 of the platform 600. The second edge unit 130 engages the corresponding top edge 502 of the package 500. The post 110 holds the two edge units 120, 130 so that they are held in fixed orientation an adjustable distance apart. The security collar with tightening nut 140 presses the second edge unit 130 toward the first edge 120. In this way, the first edge unit 120 urges the platform 600 against the package 500 and the second edge unit 130 urges the package 500 against the platform. The first security device 100 clamps the package 500 and platform 600 together intermediate the first edge unit 120 and the second edge unit 130. The post 110 holds edge units 120, 130 in fixed orientation so that they cannot be easily twisted or turned off the package 500 or the platform 600.

The first edge unit 120 has a first edge brace 122 and a second edge brace 124 which abut against respective perimeter edges of the platform 600 which converge to the edge 602 of the platform.

The first edge brace 122 and the second edge brace 124 converge to an internal corner 123 which receive an edge of the platform 600 formed by a perimeter edge and the under-edge. So the first edge unit 120 has an internal corner 123, 125 which receives the external edge 602 of the platform. This makes it difficult for the first edge unit 120, and therefore the first security device 100, to be removed from the platform 600 when the edge 602 is clamped in the first edge unit 120.

The second edge unit 130 also has a first 132 and second edge brace 134 which converge to an internal corner 133 in the same fashion as the first edge unit 120. So, the second edge unit 130 internal corner 133 receives the corresponding external edge 506 of the package 500. The first and second edge braces 132, 134 abut against perimeter edges of the package 500 which converge to an external edge 506. So, the external edge 506 of package is clamped into internal corner 133 the second edge unit 130. So, it is difficult for the second edge unit 130, and therefore the first security device 100 to be removed from the package 500 when the edge 506 is clamped in the second edge unit 130.

The edge braces pairs 122, 124, 132, 134, 222, 224, 232, 234; may each be made from an “angle iron” may comprise an alloy, ceramic or polymer which is resistant to cutting or deforming.

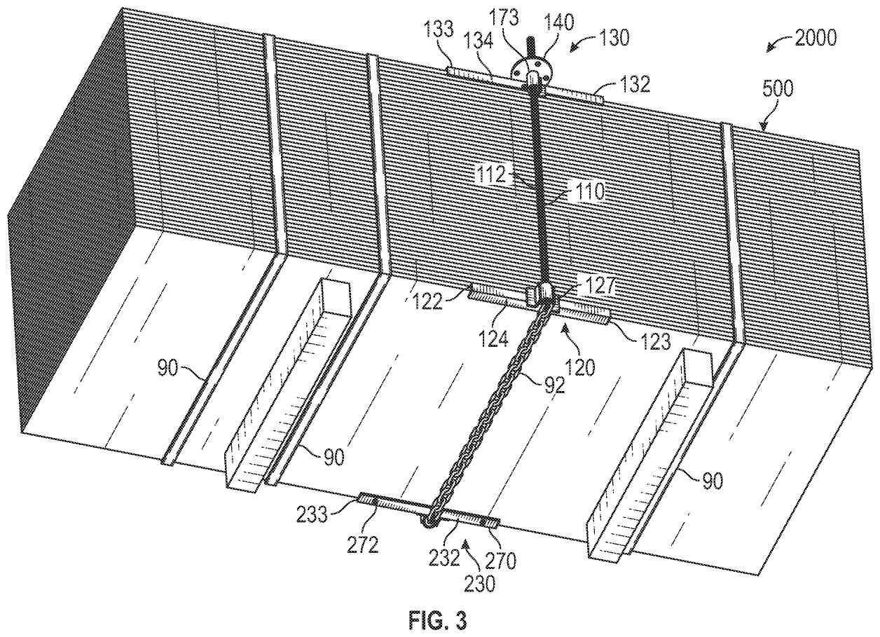

As shown in FIG. 3, A cross bar 190 over the package 500 is connected to the first security device 100 and second security device 200 at opposite edges of the package 500 to provide additional security of holding the package 500 against the platform 600.

In a preferred embodiment, there is a kit of parts for assembling a platform clamp, comprising a first edge unit 120, 220 and a second edge unit 130, 230, wherein the first edge unit 120, 220 is shaped to receive an edge of a platform 600, a post arranged to hold the edge units 120, 130, 220, 230 an adjustable distance apart; and an operable, lockable press connectable to the post to press the edge units 120, 130, 220, 230 toward each other.

In a preferred embodiment, there is a transportable platform security system for securing a package, comprising a platform 600, and first 100 and second security devices 200 each one of the security devices having a first edge unit 120, 220 wherein is received a respective edge of the platform, 602, 604, 606, 608, a second edge 130, 230 unit shaped to receive a respective edge of the package 502, 504, 506, 508, a post arranged to hold the first 120, 220 and second edge units 130, 230 an adjustable distance apart, and an operable, lockable press connected to the post to compress the package intermediate the first 120, 220 and second edge units 130, 230.

In an alternate embodiment, there is a transportable platform security system for securing a package 500 wherein the press is arranged to press the second edge unit 130, 230 toward the first edge unit 120, 220.

In an alternate embodiment, there is a transportable platform security system for securing a package wherein the first edge unit 120, 220, of each security device supports the post of the respective security device parallel to the platform 600.

In an alternate embodiment, there is a transportable platform security system for securing a package wherein an internal corner 123, 133, 223, 233 is formed in each of the first edge units 120, 220 to receive the respective edge of each platform 600 and has two edges convergent to a vertex wherein the edge are parallel.

In an alternate embodiment, there is a transportable platform security system for securing a package wherein an internal corner 123, 223 is formed in each of the first edge units 120, 220 to receive the respective edge of each platform 600.

In an alternate embodiment, there is a transportable platform security system for securing a package wherein the press is turn-able about a thread on the post to adjust the separation distance between the first 120, 220 and second edge units 130, 230 each security device.

In an alternate embodiment, there is a transportable platform security system for securing a package wherein the first edge unit 120, 220 of each of the first 100 and second security devices 200 is received in respective edges of the platform 600 which are parallel opposite each other.

In an alternate embodiment, there is a transportable platform security system for securing a package comprising a cable or chain 192 connected across the platform 600 to each of the second edge units 130, 230.

In an alternate embodiment, there is a transportable platform security system for securing a package wherein the press is lockable to the second edge unit 130, 230 or to the post to fix the distance between the first 120, 220 and second edge units 130, 230.

In an alternate embodiment, there is a transportable platform security system for securing a package wherein the post comprises an all-thread rod.

In an alternate embodiment, there is a transportable platform security system for securing a package wherein the post is through the first 120, 220 and second edge units 130, 230.

In an alternate embodiment, there is a transportable platform security system for securing a package wherein the post fits together with the first 120, 220 and second edge units 130, 230 to hold them in fixed orientation.

In an alternate embodiment, there is a transportable platform security system for securing a package wherein the second edge unit 130, 230, is intermediate the first edge unit 120, 220, and the press.

In an alternate embodiment, there is a transportable platform security system for securing a package wherein a first hole 170, 270 through the second edge unit 130, 230, is unthreaded for a screw fastener pass through to fasten the first edge unit 120, 220 to the platform 600.

In an alternate embodiment, there is a transportable platform security system for securing a package wherein a pallet comprises the platform 600 and the transportable platform comprises the pallet.

In an alternate embodiment, there is a transportable platform security system for securing a package wherein the first 120, 220 and second edge 130, 230 units are substantially the same.

In a first preferred embodiment of the invention, there is a security device for securing a package 500 onto a transportable platform 600 having a plurality of edges 602, 604, 606,608, comprising a post, a first edge unit 120, 220 and a second edge 130, 230 unit held at an adjustable distance apart by said post, wherein said first edge unit 120, 220 is shaped to receive an edge of said transportable platform 600, and an operable and lockable press connected to said post to press said edge units 120, 130, 220, 230 toward each other.

In a second preferred embodiment of the invention, there is a kit of parts for assembling a platform clamp, comprising first edge unit 120, 220 and second edge unit 130, 230, wherein said first edge unit 120, 220 is shaped to receive an edge of a platform 600, a post arranged to hold said edge units 120, 130, 220, 230, an adjustable distance apart, and an operable and lockable press connectable to said post to press said edge units 120, 130, 220, 230 toward each other.

In a third preferred embodiment of the invention, there is a transportable platform security system for securing a package on a pallet, comprising a platform 600, having a plurality of edges, a first security device 100 and a second security device 200 each one of the security devices having a first edge unit 120, 220 wherein is received a respective edge of said platform 600, a second edge 130, 230 unit shaped to receive a respective edge of the package 502, 504, 506, 508, a post arranged to hold the first 120, 220 and second edge 130, 230 units an adjustable distance apart, and an operable and lockable press connected to said post to compress the package intermediate the first 120, 220 and second edge units 130, 230.

In an alternative embodiment of the invention, there is a transportable platform security system as in the third preferred embodiment, wherein said press is arranged to press the second edge unit 130, 230, toward the first edge unit 120, 220.

In an alternative embodiment of the invention, there is a transportable platform security system as in the third preferred embodiment, wherein the first edge unit 120, 220, of each security device supports said post of the respective security device parallel to the platform 600.

In an alternative embodiment of the invention, there is a transportable platform security system as in the third preferred embodiment, wherein an internal corner 123, 133, 223, 233 is formed in each of the first edge units 120, 220 and second edge units 130, 230 to receive the respective edge of each platform 600.

In an alternative embodiment of the invention, there is a transportable platform security system as in the third preferred embodiment, wherein said post is threaded along its length, and the press is turnable about a thread on said post to adjust the separation distance between said first edge unit 120, 220, and said second edge unit 130, 230, of said security device.

In an alternative embodiment of the invention, there is a transportable platform security system as in the third preferred embodiment, wherein said post is comprising a cable or chain 192 connected across the platform 600 to each of said first edge unit 120, 220 and said second edge unit 130, 230.

In an alternative embodiment of the invention, there is a transportable platform security system as in the third preferred embodiment, wherein said press is lockable to the second edge unit 130, 230 or to said post to fix a distance between said first edge unit 120, 220 and said second edge unit 130, 230.

In an alternative embodiment of the invention, there is a transportable platform security system as in the third preferred embodiment, wherein said post comprises an all-thread rod.

In an alternative embodiment of the invention, there is a transportable platform security system as in the third preferred embodiment, wherein said post is through said first edge unit 120, 220 and said second edge unit 130, 230.

In an alternative embodiment of the invention, there is a transportable platform security system as in the third preferred embodiment, wherein said post fits together with said first edge unit 120, 220, and said second edge unit 130, 230 to hold them in fixed orientation.

In an alternative embodiment of the invention, there is a transportable platform security system as in the third preferred embodiment, wherein said second edge unit 130, 230 is intermediate the first edge unit 120, 220 and the press.

In an alternative embodiment of the invention, there is a transportable platform security system as in the third preferred embodiment, wherein said pallet comprises said platform 600 and said transportable platform comprises said pallet.

In an alternative embodiment of the invention, there is a transportable platform security system as in the third preferred embodiment, comprising four security devices, each one arranged as said first security device 100 and said second security device 200 at a respective edge of said platform 600 which is rectangular with four edges.

The invention has been described by way of examples only. Therefore, the foregoing is illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Index of Labelled Features in Figures
Element 1000 is a Secured Covered Pallet of Construction Materials (Type 1).
Element 100 is a First Security Device.
Element 110 is a Post, First Security Device.
Element 112 is a Spine or Groove in Post, First Security Device.
Element 120 is a First Edge Unit, First Security Device.
Element 122 is a First Edge Brace, First Edge Unit, First Security Device.
Element 123 is an Internal Corner, First Edge Unit, First Security Device.
Element 124 is a Second Edge Brace, First Edge Unit, First Security Device.
Element 127 is a Groove in First Security Device.
Element 130 is a Second Edge Unit, First Security Device.
Element 132 is a First Edge Brace, Second Edge Unit, First Security Device.
Element 133 is an Internal Corner, Second Edge Unit, First Security Device.
Element 134 is a Second Edge Brace, Second Edge Unit, First Security Device.
Element 140 is a Security Collar with Tightening Nut, First Security Device.
Element 170 is a First Fastener, Second Edge Unit, First Security Device.
Element 172 is a Second Fastener, Second Edge Unit, First Security Device.
Element 173 is a Thorough Hole, First Security Device.
Element 200 is a Second Security Device.
Element 210 is a Post, Second Security Device.
Element 212 is a Spine or Groove in Post, Second Security Device.
Element 220 is a First Edge Unit, Second Security Device.
Element 222 is a First Edge Brace, First Edge Unit, Second Security Device.
Element 224 is a Second Edge Brace, First Edge Unit, Second Security Device.
Element 227 is a Groove in Second Security Device.
Element 223 is an Internal Corner, First Edge Unit, Second Security Device.
Element 230 is a Second Edge Unit, Second Security Device.
Element 232 is a First Edge Brace, Second Edge Unit, Second Security Device.
Element 234 is a Second Edge Brace, Second Edge Unit, Second Security Device.
Element 233 is a Internal Corner, Second Edge Unit, Second Security Device.
Element 240 Is a Security Collar with Tightening Nut, Second Security Device.
Element 270 is a First Fastener, Second Edge Unit, Second Security Device.
Element 272 is a Second Fastener, Second Edge Unit, Second Security Device.
Element 273 is a Thorough Hole, First Security Device.
Element 92 is a Chain.
Element 60 is a Padlock.
Element 90 is a Cross Bar.
Element 500 is a Package.
Element 502 is a First Edge of Package.
Element 504 is a Second Edge of Package.
Element 506 is a Third Edge of Package.
Element 508 is a Fourth Edge of Package.
Element 600 is a Platform.
Element 602 is a First Edge of a Platform.
Element 604 is a Second Edge of a Platform.
Element 606 is a Third Edge of a Platform.
Element 608 is a Fourth Edge of a Platform.
Element 2000 is a Secured Covered Pallet of Construction Materials (Type 2).

1. A security device for securing a package onto a transportable platform having a plurality of edges, comprising a post, a first edge unit and a second edge unit held at an adjustable distance apart by said post, wherein said first edge unit is shaped to receive an edge of said transportable platform, and an operable and lockable press connected to said post to press said edge units toward each other.

2. A kit of parts for assembling a platform clamp, comprising first edge unit and second edge unit, wherein said first edge unit is shaped to receive an edge of a platform, a post arranged to hold said edge units an adjustable distance apart, and an operable and lockable press connectable to said post to press said edge units toward each other.

3. A transportable platform security system for securing a package on a pallet, comprising a platform having a plurality of edges, a first security device and a second security device each one of the security devices having a first edge unit wherein is received a respective edge of said platform, a second edge unit shaped to receive a respective edge of the package, a post arranged to hold said first edge unit and said second edge unit an adjustable distance apart, and an operable and lockable press connected to said post to compress the package intermediate said first edge unit and said second edge unit.

4. The transportable platform security system according to claim 3, wherein said press is arranged to press the second edge unit toward the first edge unit.

5. The transportable platform security system according to claim 3 wherein the first edge unit of each security device supports said post of the respective security device parallel to the platform.

6. The transportable platform security system according to claim 3 wherein an internal corner is formed in each of the first edge units and second edge units to receive the respective edge of each platform.

7. The transportable platform security system according to claim 3 wherein said post is threaded along its length, and the press is turnable about a thread on said post to adjust a separation distance between said first edge unit and said second edge unit of said security device.

8. The transportable platform security system according to claim 3 wherein said post is comprising a cable or chain connected across the platform to each of said first edge unit and said second edge unit.

9. The transportable platform security system according to claim 3 wherein said press is lockable to said second edge unit or to said post to fix a distance between said first edge unit and said second edge unit.

10. The transportable platform security system according to claim 3 wherein said post comprises an all-thread rod.

11. The transportable platform security system according to claim 3 wherein said post is through said first edge unit and said second edge unit.

12. The transportable platform security system according to claim 3 wherein said post fits together with said first edge unit and said second edge unit to hold them in fixed orientation.

13. The transportable platform security system according to claim 3 wherein said second edge unit is intermediate the first edge unit and the press.

14. The transportable platform security system according to claim 3 wherein a first hole through said first edge unit is unthreaded for a screw fastener pass through to fasten said first edge unit to said platform.

15. The transportable platform security system according to claim 3 wherein said pallet comprises said platform and said transportable platform comprises said pallet.

16. The transportable platform security system according claim 3 further comprising at least a third security device arranged at a respective edge of said platform in the manner of said first security device and said second security device.

17. The transportable platform security system according to claim 3 comprising four security devices, each one arranged as said first security device and said second security device at a respective edge of said platform which is rectangular with four edges.
